(19) United States
(12) Patent Application Publication
(10) Pub. No.: US 2008/0006133 A1
(43) Pub. Date: Jan. 10, 2008

(54) Saw blade disassembling device for a table saw

(76) Inventor: Bor-Yann Chuang, Taiping City (TW)

Correspondence Address: BRUCE H. TROXELL, SUITE 1404, 5205 LEESBURG PIKE, FALLS CHURCH, VA, 22041, US

(21) Appl. No.: 11/480,441

(22) Filed: Jul. 5, 2006

(51) Int. Cl. B27B 27/06; B27B 27/04

(52) U.S. Cl. 83/471.3; 83/477.2; 83/581

(57) ABSTRACT

A saw blade disassembling device for a table saw includes a saw base and a work table. The saw base consists of a main shaft holder, a main shaft and a saw blade. The main shaft is pivotally positioned in the main shaft holder, and the saw blade is fixed at the front end of the main shaft. The main shaft has its outer circumference equidistantly bored with plural locking holes. The worktable has its upper side bored with a positioning groove corresponding to the locking hole of the main shaft. The positioning groove is fitted with a locking pivot extending downward to form a positioning rod, which can be actuated to move up and down axially in the positioning groove and be inserted in one of the locking holes of the main shaft to fix the main shaft in position for facilitating disassembling of the saw blade.

### BACKGROUND OF THE INVENTION

1. Field of the Invention

This invention relates to a saw blade disassembling device for a table saw, particularly to one having a locking pivot fitted in the positioning groove of a work table. The locking pivot has its lower end extending downward to form a positioning rod to be inserted in one of the locking holes of a main shaft so as to fix the main shaft in position for facilitating disassembly of the saw blade of a table sawing machine.

2. Description of the Prior Art

A conventional table saw, as shown in FIG. 1, includes a main shaft holder 1, a main shaft 2 and a saw blade 3 combined together. The main shaft holder 1 is fixedly assembled at a preset position of a table saw, and the main shaft 2 is pivotally positioned in the main shaft holder 1 and driven to rotate by a motor. The saw blade 3 is fixed at the front end of the main shaft 2 by a nut 4 to be rotated together with the main shaft 2 for carrying out cutting of a work piece.

However, after the saw blade 3 of the conventional table saw is used for a period of time, it will become worn off and have to be replaced with a new one. To replace the saw blade 3, the main shaft 2 has to be fixed first with one spanner and then the nut 4 on the main shaft 2 is unscrewed with another spanner for removing the saw blade 3 from the main shaft 2, quite inconvenient in disassembling of the saw blade 3.

### SUMMARY OF THE INVENTION

The objective of the invention is to offer a saw blade disassembling device for a table saw, which includes a saw base and a work table. The saw base consists of a main shaft holder, a main shaft and a saw blade. The main shaft holder is pivotally assembled at the inner side of a table saw and has its upper side vertically bored with a positioning hole at a preset location. The main shaft is pivotally positioned in the main shaft holder and has its central portion fixed with a positioning ring having its outer circumference equidistantly bored with a plurality of locking holes corresponding to the positioning hole of the main shaft holder. The saw blade is fixed at the front end of the main shaft by a nut. The worktable has its upper side bored with a positioning groove corresponding to the locking hole of the main shaft. The positioning groove is fitted therein with a locking pivot having its lower end extending downward to form a positioning rod, which can be actuated to move up and down axially in the positioning groove and be inserted in the locking hole of the main shaft to fix the main shaft in position for facilitating disassembly of the saw blade.

### BRIEF DESCRIPTION OF DRAWINGS

This invention will be better understood by referring to the accompanying drawings, wherein:

FIG. 1 is a side cross-sectional view of a conventional table saw;

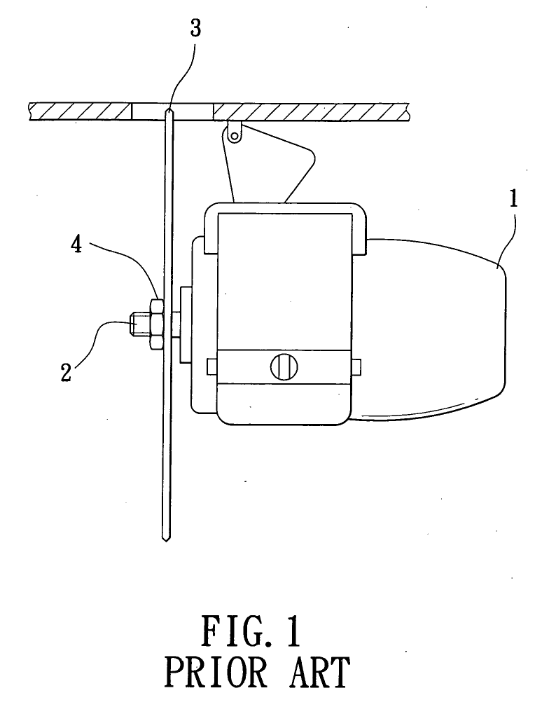

FIG. 2 is a perspective view of a table saw in the present invention;

FIG. 3 is a partial side cross-sectional view of a saw blade-disassembling device for a table saw in the present invention;

FIG. 4 is a front cross-sectional view of the saw base of a table saw in the present invention; and

FIG. 5 is a side cross-sectional view of a positioning rod fixing the saw base in position in the present invention.

### DETAILED DESCRIPTION OF THE PREFERRED EMBODIMENT

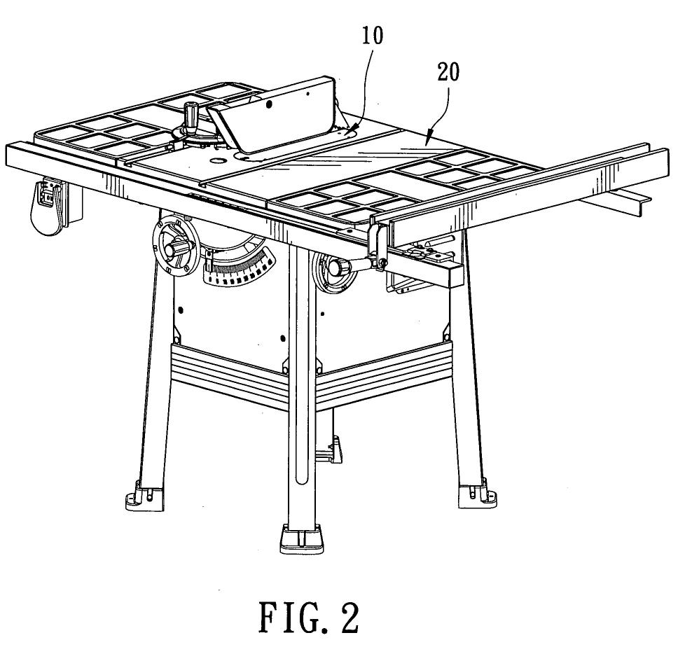

A preferred embodiment of a saw blade disassembling device for a table saw in the present invention, as shown in FIGS. 2, 3 and 4, includes a saw base 10 and a worktable 20.

The saw base 10 consists of a main shaft holder 11, a main shaft 12 and a saw blade 13. The main shaft holder 11 has its upper side vertically bored with a positioning hole 111 at a preset location. The main shaft is pivotally positioned in the main shaft holder 11 and has its central portion fixed at a preset location with a positioning ring 14 having its outer circumference diametrically and equidistantly bored with four locking holes 141 corresponding to the positioning hole 111 of the main shaft holder 11. The saw blade 13 is firmly fitted at the front end of the main shaft 12 by a nut 121.

The worktable 20 has its upper side bored with a positioning groove 21 corresponding to the positioning hole 111 of the main shaft holder 11. The positioning groove 21 has its bottom vertically bored with a through hole 211 and is fitted therein with a locking pivot 22 able to perform reciprocating motion axially for a preset stroke in the positioning groove 21. The locking pivot 22 has its lower end extending downward to form a positioning rod 221 having a protruding position-limiting tray 222 secured under the locking pivot 22. An elastic member 23 (a compression spring) has a diameter a bit larger than that of the position-limiting tray 222. After the elastic member 23 is fitted on the position-limiting tray 222, the locking pivot 22 is inserted in the positioning groove 21, letting the elastic member 23 restricted to position between the positioning groove 21 and the locking pivot 22. Further, after inserted through the through hole 211 at the bottom of the positioning groove 21, the positioning rod 221 has its lower end secured with a position-limiting member 223.

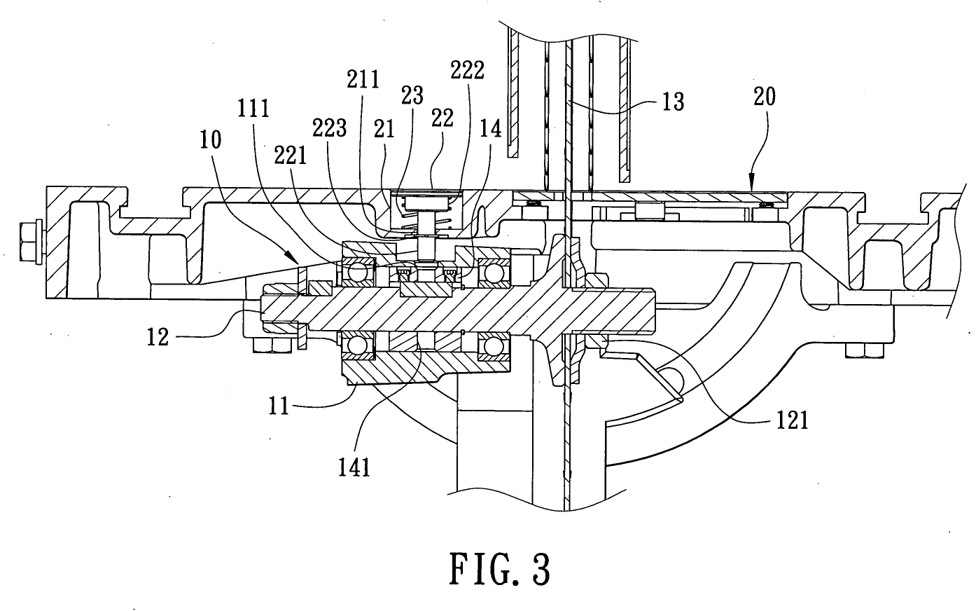

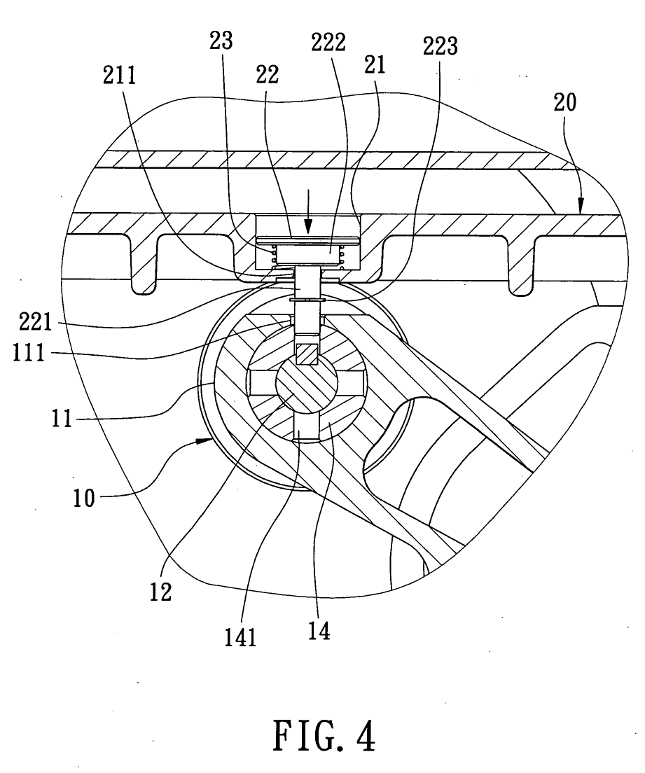

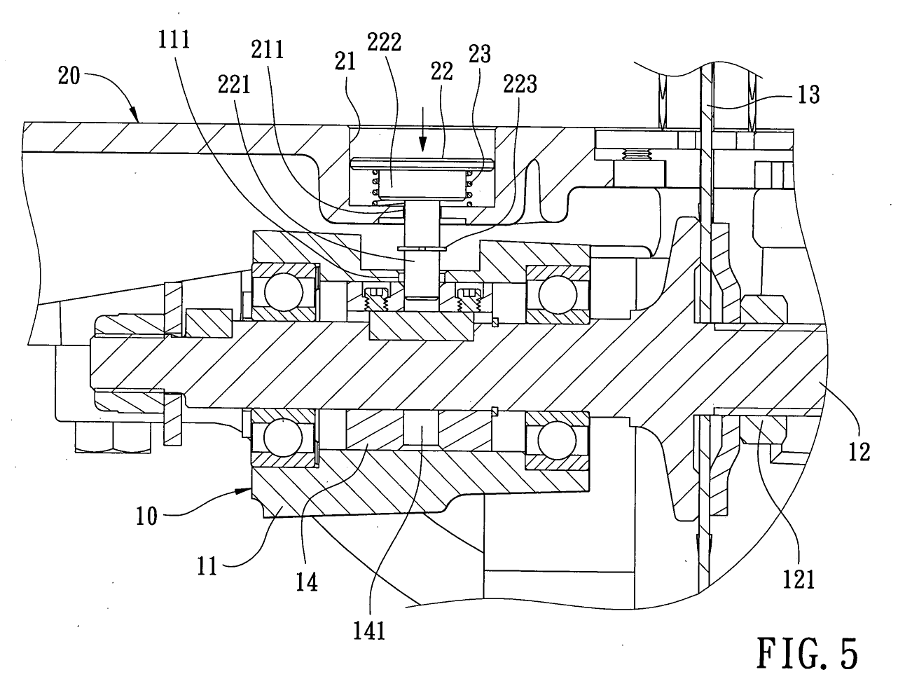

In operating, as shown in FIG. 3, the main shaft 12 is driven to actuate a saw blade to rotate and cut the work piece on the worktable. When the saw blade 12 is worn off and needs to be replaced, referring to FIGS. 4 and 5, simply press down the locking pivot 22 to let the lower end of the positioning rod 221 pass through the positioning hole 111 of the main shaft holder 11 and touch the positioning ring 14 on the main shaft 12. Next, slightly turn the main shaft 12 to let the locking hole 141 of the positioning ring 14 and the positioning hole 111 of the main shaft holder 11 aligned to each other and then push downward the positioning rod 221 to let its lower end engaged in the locking hole 141 of the positioning ring 14, letting the main shaft 11 impossible to be rotated any longer. At this time, the nut 121 on the main shaft 12 can be unscrewed with a spanner to remove the saw blade 13 from the main shaft 12. When the locking pivot 22 is pressed, the elastic member 23 will be compressed; therefore, after the saw blade 13 is disassembled from the main shaft 12 and the locking pivot 22 is released, the locking pivot 22 will recover its original position by the recovering elasticity of the elastic member 23.

As can be understood from the above description, this invention has the following advantages.

1. During disassembling of the saw blade, the main shaft is fixed in position by the positioning rod; therefore, the saw blade can be disassembled from the main shaft with only one spanner, and removed simply and quickly.

2. The locking pivot is provided on the upper side of the worktable so it can be operated conveniently, conforming to ergonomics.

While the preferred embodiment of the invention has been described above, it will be recognized and understood that various modifications may be made therein and the appended claims are intended to cover all such modifications that may fall within the spirit and scope of the invention.

I claim:

1. A saw blade disassembling device for a table saw, said device comprising a saw base and a work table, said saw base comprising a main shaft holder, a main shaft and a saw blade, said saw base assembled at a preset location of a table saw, said main shaft pivotally positioned in the interior of said main shaft holder, said saw blade fixed at the front end of said main shaft, said main shaft rotated to actuate said saw blade to rotate and cut the work piece on said work table: and characterized by,
Said main shaft holder of said saw base having its upper side vertically bored with a positioning hole at a preset location, said main shaft having its outer circumference diametrically and equidistantly bored with a plurality of locking holes at the locations corresponding to said positioning hole of said main shaft holder: and
Said work table having its upper side bored with a positioning groove at a location aligned to said positioning hole of said main shaft holder, said positioning groove having its bottom center bored with a through hole, said positioning groove fitted therein with a locking pivot having its lower end extending downward to form a positioning rod, said positioning rod inserted through said through hole of said positioning groove after fitted thereon with an elastic member, said elastic member restricted and fixed between said locking pivot and said positioning groove, said positioning rod having its lower end secured with a position-limiting member after inserted through said through hole at the bottom of said positioning groove, said locking pivot able to perform reciprocating motion axially for a preset stroke in said positioning groove, said locking pivot pressed to make the lower end of said positioning rod engaged in said locking hole of said main shaft for fixing said main shaft in position, said elastic member compressed when said locking pivot is pressed, said elastic member recovering its elasticity to actuate said locking pivot to recover its original position when said locking pivot is released.

2. The saw blade disassembling device for a table sawing machine as claimed in claim 1, wherein said main shaft has its central portion fixed thereon with a positioning ring, said positioning ring having its outer circumference diametrically and equidistantly bored with plural locking holes preset in number.

3. The saw blade disassembling device for a table sawing machine as claimed in claim 1, wherein said positioning rod is provided with a protruding position-limiting tray with a diameter somewhat smaller than that of said elastic member, said elastic member having its upper end firmly fixed on said position-limiting tray after said elastic member is fitted on said positioning rod.

4. The saw blade disassembling device for a table sawing machine as claimed in claim 1, wherein said elastic member is a compression spring.
